(19) United States
(12) Patent Application Publication
(10) Pub. No.: US 2006/0132702 A1
(43) Pub. Date: Jun. 22, 2006

(54) Method for producing a liquid crystal panel

(75) Inventors: Te-Sheng Chen, Chu Pei City (TW); Kai-Neng Yang, Tainan City (TW); Chia-Hsuan Tai, Taichung City (TW)

Correspondence Address: BRUCE H. TROXELL, SUITE 1404, 5205 LEESBURG PIKE, FALLS CHURCH, VA, 22041, US

(73) Assignee: AU Optronics Corp.

(21) Appl. No.: 11/302,272

(22) Filed: Dec. 14, 2005

(30) Foreign Application Priority Data
Dec. 17, 2004 (TW) 93139532

(51) Int. Cl. G02F 1/13

(52) U.S. Cl. 349/187

(57) ABSTRACT

A method of manufacturing an LCD panel, which the LCD panel includes a first substrate and a second substrate, includes following steps of: 1) forming an alignment layer on the first and second substrates, the alignment layer comprising PI and PAA; 2) post baking to convert PAA into PI, wherein the imidization rate of the alignment layer after the post baking is between 70% and 90%; 3) spreading a sealant in the margin area of the first substrate; 4) dropping a liquid crystal material upon the first substrate; and 5) gluing the first substrate and the second substrate under a low-pressure condition.

### (1) FIELD OF THE INVENTION

The present invention relates to a method for producing a liquid crystal panel, and more particularly to a one-drop-fill (ODF) method of manufacturing a liquid crystal panel.

### (2) DESCRIPTION OF THE PRIOR ART

Liquid crystal display (LCD) panels are key elements of plan displays, In the LCD panel, liquid crystals are sealed, by a proper sealant, within two substrates. One of the two substrates comprises an electrode pixel array, which the electrode pixel forming the element of the electrode pixel array is used for controlling the spin angle of the liquid crystal molecules. The other substrate comprises a color filter used for presenting colorful images of the panel.

Please refer to FIG. 1A, in which a set 12 of a pair of substrates integrated by a circling sealant 13 is positioned in a vacuum chamber 10. The substrate set 12 comprises a first substrate 121 and a second substrate 123, and one of the substrates 121 or 123 includes an electrode pixel array while the other includes color filters. The substrate set 12 is sealed by circumference sealant 13 but leaving an opening 14 for injection of liquid crystal molecules. Meanwhile, an air extracting apparatus can be used to lower the air pressure of the vacuum chamber 10 so that a vacuum anneal process can be processed to make sure a complete removal of water. The opening 14 is about 1 cm wide. Empirically, a smaller size panel (less than 7 inch) has one opening 14 while a larger size panel (larger than 15 inch) has at least two openings.

In the step of injecting liquid crystal molecules into the substrate set 12, an LC boat 16 is used to engage the opening 14 and to inject an inert gas into the vacuum chamber 10 such that a press drop can be formed between the vacuum chamber and the interior pressure of the substrate set 12. Through the pressure drop and the capillary phenomenon between the sealed substrates 121 and 123, the liquid crystal molecules can be sucked up and filled into the substrate set 12. Then, the opening 14 is sealed by the sealant so as to form an airtight interior between the two substrates 121 and 123 (as shown in FIG. 1C).

In the art, the method mentioned above takes too much time in injecting liquid crystals. Generally, the injection process takes 3-5 hours for small size panels, and up to a whole day for larger panels.

It is known in the art that the LCD can be filled by the so-called “ODF” (One drop fill) method (see U.S. Pat. No. 5,263,888), briefly described by FIG. 2A through FIG. 2C.

As shown in FIG. 2A, a sealant 13 is formed firstly in the margin area of the upper surface of one of the two substrates, herein the substrate with the sealant 13 on top is named as the first substrate 121.

Please refer to FIG. 2B, which shows how a special nozzle tip 20 drops liquid crystals 22 to the upper surface of the first substrate 121. The nozzle tip 20 could drop at one drop of liquid crystals 22 per one time, and thereby liquid crystals 22 are gradually lay over the upper surface of the first substrate 121. This kind of liquid crystal injection technique is called a name of ODF (One Drop Fill) technique.

The ODF technique is developed to overcome the time-consuming problem in the conventional liquid crystal injection process described from FIG. 1A to FIG. 1C. The ODF technique doesn't restrict the number of nozzle tips 20. That is to say that multiple nozzle tips 20 can work simultaneously, as shown in FIG. 2B. Also, by providing the ODF technique, no matter what size of panel is, only a few minutes are required to drop the needed quantity of the liquid crystals over the substrate 121 of the panel.

Finally, as FIG. 2C shows, the first substrate 121 and the second substrate 123 are moved into a vacuum chamber 10 and gluing the second substrate 123 upon the first substrate 121 under a condition of reduced ambient air pressure (less than 1 pa). The sealant 13 on the upper surface of the first substrate 121 could then combine the two substrates 121 and 123, and a UV irradiation treatment can be used to solidify the sealant 13.

Moreover, there're alignment layers on both the upper surface of the first substrate 121 and the lower surface of the second substrate 123. The alignment layers contact liquid crystal and control the arrangement direction of the liquid crystals. In sealing the two substrates 121 and 123, the couple angle of the alignment layers is one of the keys to effect the quality of the panel.

Nevertheless, the ODF technique exists a big inherent defect as follows. Please refer to FIG. 3, which shows mura 24 on the LCD panel 8. Empirically, the positions of mura 24 on the upper surface of the first substrate 121 happen to match the positions of the landing points of the liquid crystal drops 22 from the nozzle tips 20. In the art, such a mura arrangement is not found in panels produced by any other existing LC filling technique, and so such type of the mura 24 is called as an ODF mura.

Some suppose that “the process in FIG. 2B is not operated in a sufficient vacuum chamber” is the major cause of the phenomenon mura. Moreover, another possible reason to cause the mura 24 might be the lack of vacuum thermal tempering process before dropping liquid crystal 22 in the ODF technique, and so residue water may still adhere on the alignment layers of the first substrate 121. The material of alignment layers is composed of polyimide (PI) and polyamic acid (PAA), whose chemical formula are shown as follows.

The chemical formula of PI:

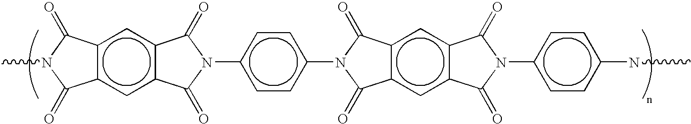

The chemical formula of PAA:

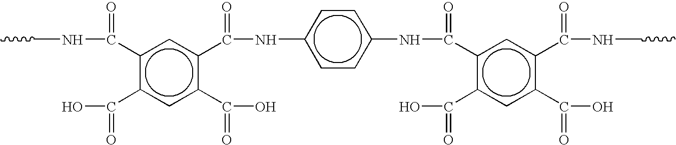

Though the process in FIG. 2C is operated in the vacuum chamber 10, yet partial water steam may be still capped by the dropped liquid crystals 22 and may further cause the phenomenon of ODF mura in a later time. However, the reason that the prior art doesn't operate the liquid dropping process in the vacuum chamber is because related appliances (for instance, nozzle tips) are not convenient to be operated inside the vacuum chamber.

### SUMMARY OF THE INVENTION

The present invention introduces a method of manufacturing an LCD panel, which the LCD panel comprises a first substrate and a second substrate. The method includes following steps of: 1) forming an alignment layer on the first and second substrates, the alignment layer comprising PI and PAA; 2) post baking to convert PAA into PI, wherein the imidization rate of the alignment layer after the post baking is between 70% and 90%; 3) spreading a sealant in the margin area of the first substrate; 4) dropping a liquid crystal material upon the first substrate; and 5) gluing the first substrate and the second substrate under a low-pressure condition.

According to the present invention, the method of manufacturing a LCD panel can shorten the liquid crystal injection time, and improve the phenomenon of ODF mura without upgrading the vacuum chamber. Therefore, benefits in cost reduction and less time-consuming can be obtained.

### BRIEF DESCRIPTION OF THE DRAWINGS

The present invention will now be specified with reference to its preferred embodiment illustrated in the drawings, in which

FIG. 1A˜FIG. 1C illustrate a prior method of manufacturing a LCD panel.

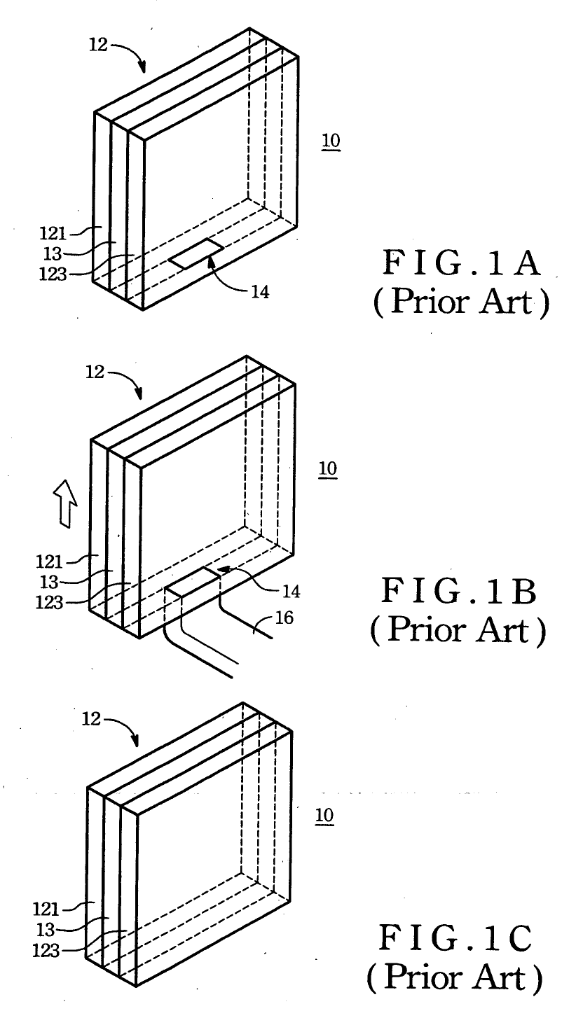

FIG. 2A˜FIG. 2C illustrate a prior method of manufacturing a LCD panel using an ODF technique.

FIG. 3 shows a defect on a LCD panel via an ODF manufacturing technique.

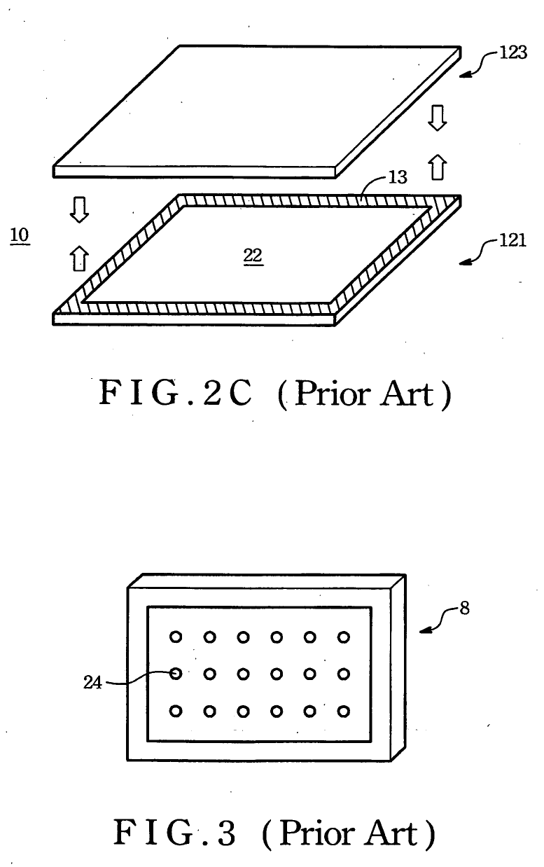

FIG. 4A˜FIG. 4D illustrate a method of the present invention of manufacturing a LCD panel.

FIG. 5 is a FTIR spectrum.

FIG. 6 is a side-view diagram of a LCD panel of the present invention.

### DESCRIPTION OF THE PREFERRED EMBODIMENT

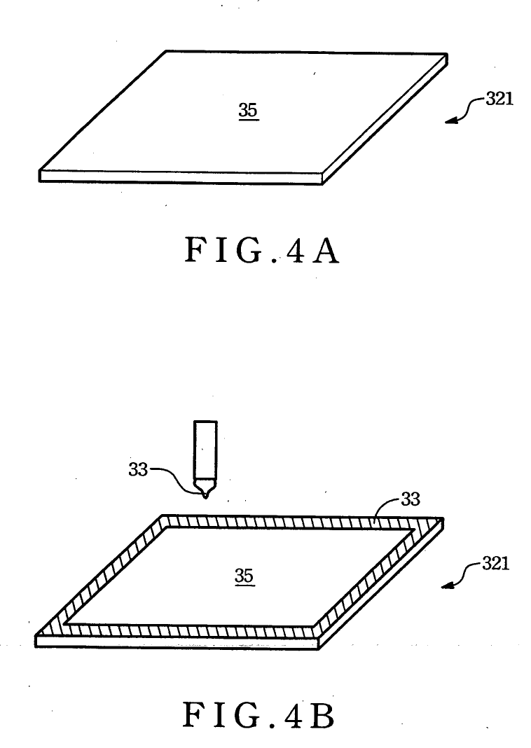

Please refer to FIG. 4A to FIG. 4D, which show four consecutive steps of a preferred ODF fabricating process of the present invention. The LCD panel herein comprises a first substrate 321 and a second substrate 323. Firstly, as FIG. 4A shows, an alignment layer 35 is applied onto the upper surface of the first substrate 321, which the alignment layer 35 is composed of PI and PAA. Then, a post baking process can be used to transfer the PAA into PI as the following formula:

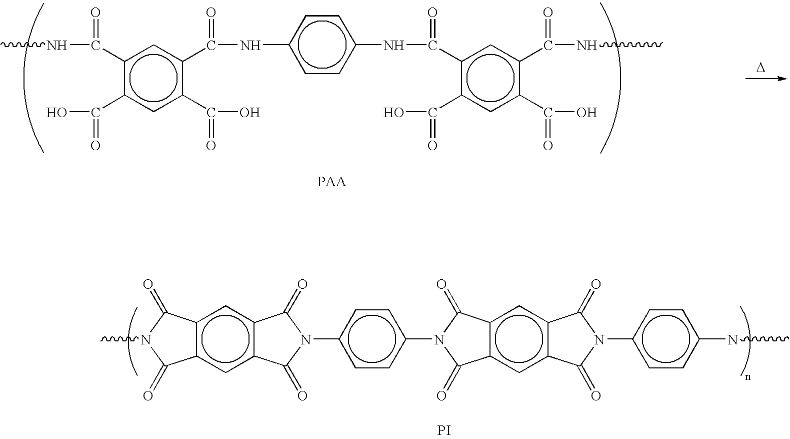

The temperature of the post baking process is in a range between 180 degree centigrade and 240 degree centigrade.

Please refer to FIG. 4A, if the LCD panel is a TN-TFT mode, an IPS mode, or an OCB mode, a a step of rubbing to arrange the alignment layer 35 with a unique angle is followed. The a step of rubbing can be accomplished by mechanical rubbing, and have advantages of being operable under room temperature and less time consumption. In another embodiment of the LCD panel being a VA mode, the a step of rubbing could be omitted.

Please refer to FIG. 4B, after the alignment layer 35 is layered, a sealant 33 is spread to the margin area of the upper surface of the first substrate 321. Now, please refer to FIG. 4C, where multiple nozzle tips 40 are used for droping a liquid crystal 42 upon the alignment layer 35. Herein, the reason of using multiple nozzle tips 40 simultaneously is because so dropping time can be greatly reduced, and thus the liquid crystal injection process can be completed within 1-2 minutes regardless of the LCD size.

Please refer to FIG. 4D, where the first substrate 321 filled with liquid crystals 42 and the second substrate 323 are moved into the vacuum chamber 10. Then, a process of gluing the second substrate 323 and the first substrate 321 under a condition of reduced ambient air pressure (less than 1 Pa) is carried out. The second substrate 323 herein has an alignment layer 37 with a unique direction in advance. Before the a step of gluing can go, an step of aligning is operated to regulate the couple angle between the alignment layer 35 and the alignment layer 37. Then, a sealant 33 is used to gluing the first and second substrates 321 and 323. Herein, the sealant 33 can be solidified via UV irradiation and heating.

The present invention controls the composition of the alignment layers and reduces the moisture residing at the alignment layers. The original material of the alignment layers includes PI (polyimide) and PAA (polyamic acid), in which PI has characters of higher mechanical strength, nice thermal tolerance, nice electric insulation, and being able to endure chemical solvents and radiation. Therefore, PI could worked stably to ensure the LCD panel a better imaging quality, even that PI contacts the liquid crystal 42 directly or that the LCD works in an environment of heat and electro-magnetic fields.

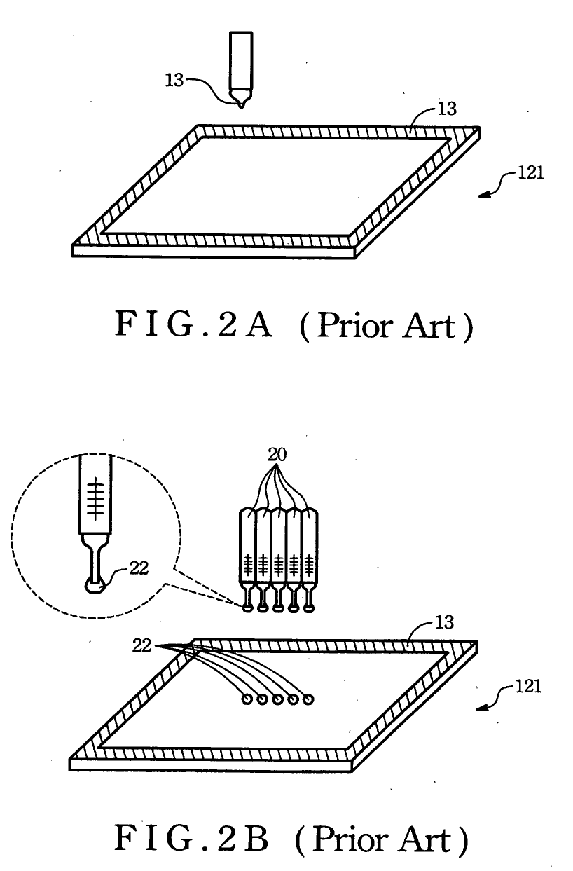

However, it's not easy to print PI onto the surface of the substrate, therefore a typical process is introduced to mix PAA and PI so as to make the following application process easier. After the mixture of the PAA and PI is applied to the alignment layer, a post baking process is applied to convert PAA into PI. Empirically, a large amount of side chains of PAA causes a low imidization rate, which the imidization rate symbolizes the degree of PAA transferred into PI. Hence, the water steam may be adsorbed by PAA and finally lead to the ODF mura shown in FIG. 2B.

It is found that, while the imidization rate of the alignment layer 35 after the post baking is larger than 70% (PAA transferred to PI), no ODF mura phenomenon can occur in the LCD panel 32. But if the imidization rate of the alignment layer 35 after the post baking is 100%, lack of PAA may result in a reduced printed and adhered ability of the alignment layer 35. After repeating experiments, it is found that an acceptable imidization rate of the alignment layer 35 after the post baking is between 70% and 90%, preferrably between 75% and 80%.

In the present invention, for making sure that the PI amount of alignment layer 35 is already enough, a step of detecting is processed. Herein, an FTIR spectrometer is used to detect the imidization rate of PI. The control group herein is a sample with 100% transferred PI (called as the reference PI in order to be distinct from the sample PI from a real alignment layer 35). The reference PI is post baked at approximately 300 degree centigrade for 60 minutes. The Fourier Transform Infrared Spectrometer (FTIR) detecting test utilizes the C—N bond, benzene ring, and C═O bond of formula 1 to detect imidization rate of the sample PI.

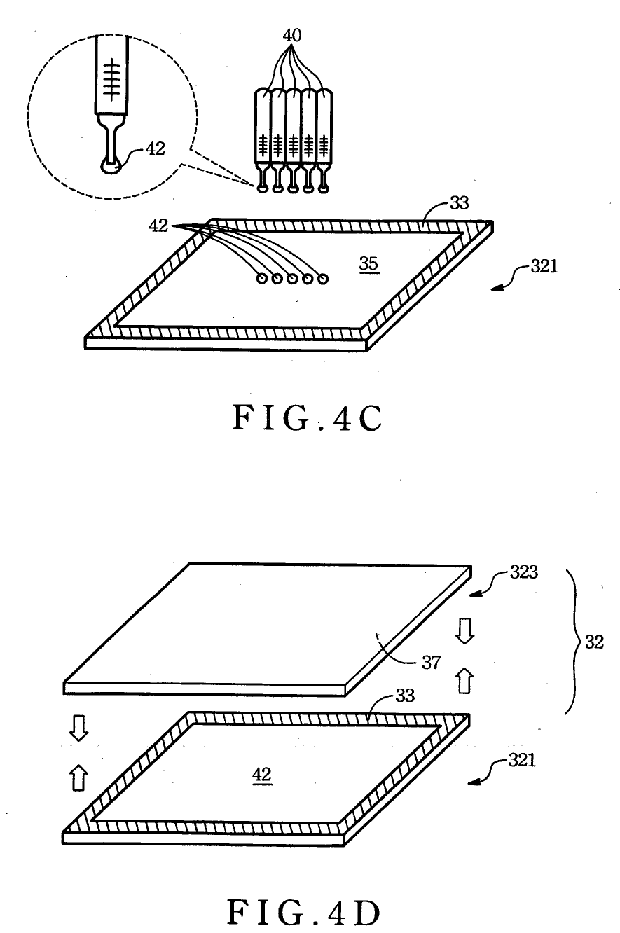

Please refer to FIG. 5, which shows an FTIR spectrum of a PI alignment layer. The horizontal axle is the frequency of light, and the vertical axle is the intensity of light absorbing. Curve I is sample I with low imidization rate (30%); curve II is sample II with 80% imidization rate; and curve III is the reference PI with 100% imidization rate. The 1380 cm-1 in the FTIR spectrum stands for the C—N bond, the 1510 cm-1 stands for the benzene ring, and the 1780 cm-1 stands for a C═O bond.

In one embodiment of the present invention, the imidization rate can be calculated according to the following formula:
imidization rate=(X/Y)*100%

in which X is the light absorb rate of the C—N bond (1380 cm-1) to the benzene ring (1510 cm-1) of sample I, and Y is the light absorb rate of the C—N bond (1380 cm-1) to the benzene ring (1510 cm-1) of the reference PI.

In another embodiment of the present invention, the imidization rate can also be obtained according to the following formula:
imidization rate=(Z/Y)*100%
in which Z is the light absorb rate of the C═O bond (1780 cm-1) to the benzene ring (1510 cm-1) of sample I and Y is the light absorb rate of the C═O bond (1780 cm-1) to the benzene ring (1510 cm-1) of the reference PI.

In the present invention, after the imidization rate of the PI content (70%˜90%) in the alignment layer 35 (after the post baking) is detected and confirmed, then other process can go in. Thereby, the ODF mura that appeared in prior arts could never happen here.

Please refer to table 1, which shows some experimental data during the process of PAA being transferred to PI.

| | PI Primary | PI Final | Moisture | | |
|---|---|---|---|---|---|
| | content | content | absorption rate | printable | ODF mura |
| Sample I | 0% | 30% | 1.50% | nice | obvious |
| Sample II | 50% | 80% | 0.60% | nice | none |
| Sample III | 100% | 100% | 0.30% | bad | none |

From table 1 and the numerous repeating experiments, it is found that, while the PI content of alignment layer 35 is less than 35%, an obvious phenomenon of ODF mura will appear, and that the phenomenon of ODF mura will get improved while the PI content of alignment layer 35 is higher than 70%.

On the other hand, the temperature of the post baking process may hurt the first and second substrates 321 and 323 while in gaining the imidization rate over 70%. To avoid possible thermal damage to the substrates, the temperature of the post baking process is preferably between 180 degree centigrade and 240 degree centigrade.

Also, the content of PI in the alignment layer before the post baking has to be considered. As the table 1 shows, the sample with high content (100%) PI is not easy to print onto the substrate, and the sample with low content (40%) will cause the phenomenon of ODF mura. Therefore, the PI content of the alignment layer before the post baking is preferably ranged between 40% and 65%.

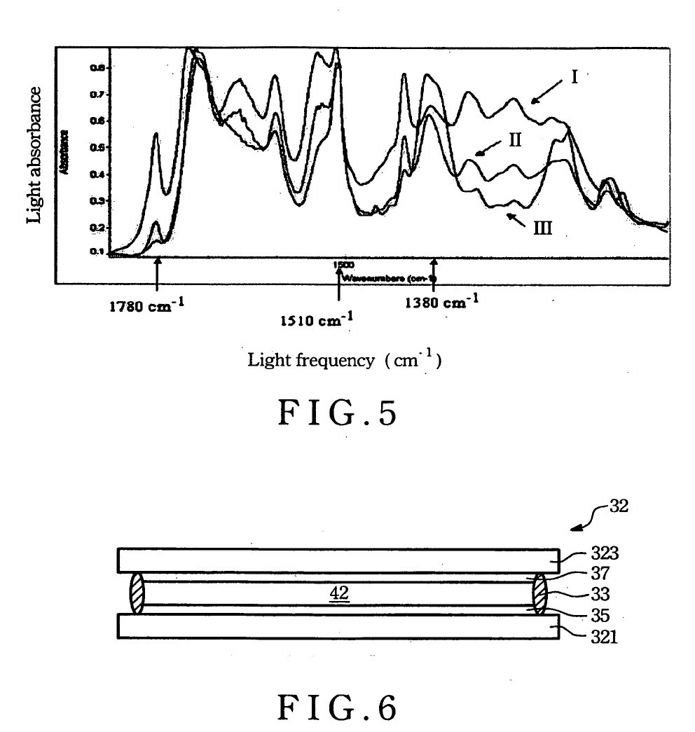

Please refer to FIG. 6, which is a side-view diagram of a LCD panel of the present invention. The LCD panel 32 comprises a first substrate 321, an alignment layer 35, a sealant 33, a second substrate 323, and a liquid crystal 42, wherein the liquid crystal 42 is filled between the first substrate 321 and the second substrate 323. The alignment layer 35 is layered on the upper surface of the first substrate 321, wherein the content of PI of the alignment layer 35 after the post baking is between 70%-90%. The sealant 33 is used to gluing the first and second substrates 321 and 323, and the second substrate 323 herein has an alignment layer 37 with a unique direction in advance.

According to above description, by providing the method of manufacturing an LCD panel in accordance with the present invention, the liquid crystal injection time can be greatly saved, and the phenomenon of ODF mura can be avoided.

We claim:

1. A method of manufacturing a liquid crystal display (LCD) panel having a first substrate and a second substrate, the method comprising:
forming an alignment layer on the first substrate and the second substrate, the alignment layer comprising polyimide (PI) and polyamic acid (PAA);
conducting a post baking to convert PAA into PI, wherein the imidization rate of the alignment layer after the post baking is between 70% and 90%;
spreading a sealant on the margin area of the first substrate;
dropping a liquid crystal material on the second substrate; and
gluing the first substrate and the second substrate to contain the liquid crystal material inside the area surrounded by the sealant therebetween.

2. The method according to claim 1, wherein the imidization rate of PI of the alignment layer before the post baking is between 40% to 65%.

3. The method according to claim 1, further comprising a step of rubbing the alignment layer before the step of spreading the sealant.

4. The method according to claim 1, further comprising a step of aligning the first substrate with the second substrate before the step of gluing the first substrate and the second substrate.

5. The method according to claim 1, further comprising a step of detecting the content of transferred PI of the alignment layer after the sstep of conducting the post baking to confirm if the content of transferred PI of the alignment layer is within 70%-90%.

6. The method according to claim 5, wherein the step of detecting is achieved by Fourier Transform Infrared Spectrometer (FTIR).

7. The method according to claim 6, wherein the step of detecting comprising comparing the alignment layer with a reference with totally transferred PI.

8. The method according to claim 7, wherein the reference is formed by post baking under approximately 300 degree centigrade for about 60 minutes.

9. The method according to claim 6, wherein the step of detecting comprising detecting the light absorption rate of C—N bond to benzene ring.

10. The method according to claim 6, wherein the step of detecting comprising detecting the light absorption rate of C═O bond to benzene ring.

11. The method according to claim 1, wherein the temperature of the post baking step is ranging from about 180 degree centigrade to about 240 degree centigrade.

12. The method according to claim 1, wherein the step of gluing the first substrate and the second substrate is under a condition of reduced ambient air pressure.

13. The method according to claim 12, wherein the pressure of reduced ambient air is less than 1 Pa.

14. A liquid crystal display (LCD) panel comprising:
a first substrate;
a second substrate;
two alignment layer formed on a top surface of the second substrate and a bottom surface of the first substrate, respectively, at least one of the two alignment layers having 70% to 90% polyimide (PI);
a sealant disposed on a margin area of the first substrate, wherein the first substrate superposes to the second substrate via the sealant; and
at least one drop of a liquid crystal material filled between the upper and second substrates.
